(19) United States
(12) Patent Application Publication
(10) Pub. No.: US 2023/0060550 A1
(43) Pub. Date: Mar. 2, 2023

(54) GENERATING SUGGESTIONS FOR USERS BASED ON IDENTIFYING DIRECT INTERACTIONS IN GROUP CHATS

(71) Applicant: Microsoft Technology Licensing, LLC, Redmond, WA (US)

(72) Inventors: Bo LIU, Sammamish, WA (US); Ke WANG, Redmond, WA (US)

(21) Appl. No.: 17/792,913

(22) PCT Filed: Jan. 15, 2021
(86) PCT No.: PCT/US2021/013672

§ 371 Date: Jul. 14, 2022

(30) Foreign Application Priority Data
Jan. 15, 2020 (NL) 2024677

(51) Int. Cl. G06Q 50/00

(52) U.S. Cl. CPC G06Q 50/01

(57) ABSTRACT

Group chats that a particular user has participated in can be analyzed for information that could be relevant to the user, such as information related to people with whom the user has directly interacted in one or more group chats. A machine learning model can be used to analyze group chats for relevant information. Data from peer-to-peer chats can be used to train the machine learning model to recognize direct, person-to-person interactions in a group chat. After the machine learning model has been trained in this way, data from group chats can be provided as input to the machine learning model, and the machine learning model can identify direct, person-to-person interactions that occurred in the group chats. Information related to these direct, person-to-person interactions can then be presented to the user in appropriate circumstances.

### BACKGROUND

Messaging applications (or “apps”) have become quite popular and are widely used for communicating with other people. Some messaging apps offer web-based versions or software for desktop operating systems. Messaging apps are also frequently used via mobile apps on smartphones or tablet computers.

Messaging apps can include a wide variety of features to users, including the ability to participate in conversations. Such conversations are often referred to as chats. In the context of computers, the term “chat” can refer to any kind of electronic communication over a computer network that offers a real-time (or near real-time) transmission of text-based messages from a sender to one or more receivers. For example, when one person who is participating in a chat inputs a message into a computing device and takes some action (e.g., clicking a send button), that message can appear on another user's device (or multiple users' devices) almost immediately. Chat messages are generally short in order to enable other participants to respond quickly. This creates a feeling similar to a spoken conversation, which distinguishes chatting from other kinds of text-based online communication such as email and Internet forums.

Chats can involve two or more people. A chat involving only two people is sometimes referred to as a peer-to-peer chat, while a chat involving more than two people is sometimes referred to as a group chat.

Some software systems have the ability to provide suggestions to users. For example, autocomplete is a feature in which an application predicts the rest of a word a user is typing. Similarly, a search engine can offer suggestions while a user is entering a search query. Before the query is complete, a drop-down list with one or more suggested completions can be presented to provide the user with options to select. As another example, social networking services can make suggestions about people with whom a user might be interested in connecting.

These and other kinds of automatically generated suggestions can help people to be more productive. To this point, however, no software system has automatically generated suggestions for users based on analyzing group chat data.

### SUMMARY

In accordance with one aspect of the present disclosure, a system is disclosed that includes a machine learning model that has been trained, based on peer-to-peer chats involving a first person, to recognize direct interactions between the first person and another person. The system also includes direct interaction data that indicates direct, person-to-person interactions involving the first person in a plurality of group chats. The direct interaction data is generated by the machine learning model in response to processing group chat data corresponding to the plurality of group chats. The system also includes a suggestion engine that is configured to cause information to be presented to the first person based on the direct interaction data. The information is related to one or more people with whom the first person has directly interacted in a group chat.

The suggestion engine may be configured to cause the information to be presented to the first person in response to receiving a search request from the first person.

The search request may include a first letter of a name of a second person. The information that is presented to the first person may include the name of the second person.

The suggestion engine may be configured to prioritize the name of the second person above other names that have a same first letter as the name of the second person.

The search request may include a name of a second person. The information that is presented to the first person may include a link to a document that the second person previously shared with the first person.

The search request may include a request to search for documents that were previously shared with the first person. The information that is presented to the first person may include a link to a document that a second person previously shared with the first person.

The information that is presented to the first person may include a reminder about a commitment that the first person made to a second person.

The information may be presented to the first person in response to receiving a search request from the first person. The direct interaction data may indicate that the first person has directly interacted with a second person in at least one group chat. The suggestion engine may be additionally configured to search a contact list that is associated with the second person in response to the search request. The information that is presented to the first person may include a name of a third person. The third person may be in the contact list that is associated with the second person. The third person may not be in any contact list that is associated with the first person.

The suggestion engine may be additionally configured to detect whether the first person selected the information and provide an indication of the first person's selection or non-selection of the information as feedback to the machine learning model for further training of the machine learning model.

In accordance with another aspect of the present disclosure, a method is disclosed that includes providing group conversation data as input to a machine learning model. The group conversation data corresponds to a plurality of group conversations involving a first person. The machine learning model has been trained to recognize direct interactions between the first person and another person. The method further includes receiving direct interaction data as output from the machine learning model. The direct interaction data indicates direct, person-to-person interactions between the first person and another person in the plurality of group conversations. The direct interaction data is generated by the machine learning model in response to processing the group conversation data. The method further includes causing information to be presented to the first person based on the direct interaction data. The information is related to one or more people with whom the first person has directly interacted in a group conversation.

The method may further include training the machine learning model using peer-to-peer conversation data from peer-to-peer conversations involving the first person.

The method may further include receiving a search request from the first person. The information may be presented to the first person in response to the search request.

The search request may include a first letter of a name of a second person. The information that is presented to the first person may include the name of the second person.

The method may further include prioritizing the name of the second person above other names that have a same first letter as the name of the second person.

The search request may include a name of a second person. The information that is presented to the first person may include a link to a document that the second person previously shared with the first person.

The search request may include a request to search for documents that were previously shared with the first person. The information that is presented to the first person may include a link to a document that a second person previously shared with the first person.

The information that is presented to the first person may include a reminder about a commitment that the first person made to a second person.

The method may further include receiving a search request from the first person and determining, based on the direct interaction data, that the first person has directly interacted with a second person in at least one group conversation. The method may further include searching a contact list that is associated with the second person in response to the search request.

The information that is presented to the first person may include a name of a third person. The third person may be in the contact list that is associated with the second person. The third person may not be in any contact list that is associated with the first person.

The method may further include detecting whether the first person selected the information and providing an indication of the first person's selection or non-selection of the information as feedback to the machine learning model for further training of the machine learning model.

In accordance with another aspect of the present disclosure, a method is disclosed that includes training a first machine learning model to recognize direct interactions involving a first person. The training of the first machine learning model is based on a first plurality of peer-to-peer chats involving the first person. The method further includes training a second machine learning model to recognize direct interactions involving a second person. The training of the second machine learning model is based on a second plurality of peer-to-peer chats involving the second person. The method further includes obtaining direct interaction data that indicates direct, person-to-person interactions in a plurality of group chats. The direct interaction data is generated by the first machine learning model and the second machine learning model in response to processing group chat data corresponding to the plurality of group chats. The method further includes causing information related to the direct, person-to-person interactions to be presented to the first person and the second person based on the direct interaction data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows.

Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example of a system for automatically generating suggestions for users based on analyzing group chats.

FIG. 2 illustrates an example of a system in which information is presented to a user about a person with whom the user directly interacted in a group chat.

FIG. 3 illustrates an example of a system in which the information that is presented to the user includes a link to a document that was previously shared with the user by someone with whom the user directly interacted in a group chat.

FIG. 4 illustrates an example of a system in which the information that is presented to the user includes a reminder about a commitment that the user previously made to someone with whom the user directly interacted in a group chat.

FIG. 5 illustrates an example of a system in which direct interaction data that is obtained from analyzing group chats can be used to connect users' networks of contacts.

FIG. 6 illustrates an example showing how data from peer-to-peer chats can be used to train a machine learning model to recognize direct interactions between two people in a group chat.

FIG. 7 illustrates an example showing how different machine learning models can be created for different users.

FIG. 8 illustrates an example of a method for automatically generating suggestions for users based on analyzing group chats.

FIG. 9 illustrates an example of a method in which direct interaction data that is obtained from analyzing group chats is used to connect users' networks of contacts.

FIG. 10 illustrates certain components that can be included within a computing device.

### DETAILED DESCRIPTION

The present disclosure is generally related to automatically generating suggestions for users based on analyzing group conversations or chats. In accordance with the present disclosure, group conversations or chats that a particular user has participated in can be analyzed for information that could be relevant to the user, such as information related to people with whom the user has directly interacted in one or more group conversations or chats. Information related to such direct interactions can be subsequently presented to the user when it could be useful.

In some embodiments, a machine learning model can be used to analyze group chats for relevant information. Data from peer-to-peer chats can be used to train a machine learning model to recognize direct, person-to-person interactions in a group chat (i.e., interactions between two people, as opposed to interactions between more than two people). After the machine learning model has been trained in this way, data from group chats can be provided as input to the machine learning model, and the machine learning model can identify direct, person-to-person interactions that occurred in the group chats. Information related to these direct, person-to-person interactions can then be presented to the user in appropriate circumstances.

For example, suppose that a user has directly interacted with someone named Bob Jones in a group chat. In accordance with the present disclosure, a machine learning model that has been trained to recognize the user's direct interactions with another person can detect that direct interaction with Bob Jones. Information related to Bob Jones can then be presented to the user at an appropriate time. For instance, if the user enters the letter “b” in a search bar, the name “Bob Jones” can be presented to the user as a suggestion in a drop-down list.

The techniques disclosed herein can enable users of various types of applications to be more efficient and productive in their interactions with others. Many users interact with a large number of other individuals each day, and it can be difficult to keep track of all of the information that is encountered during these interactions. Automatically generating suggestions for users based on analyzing group conversations or chats, as disclosed herein, reduces the amount of information that a user needs to remember.

In some embodiments, one or more suggestions for a particular user can be automatically generated in response to a search request from the user. Thus, the techniques disclosed herein can improve efficiency related to searching for and filtering data. As just one example, in the scenario discussed previously (where information is presented in response to the user entering a single letter in a search bar), the user does not have to remember the entire name of the person with whom the user interacted directly in a group chat. Instead, it is sufficient if the user merely remembers a single letter of the individual's name. Some additional examples of improved efficiency related to searching for and filtering data will be described below.

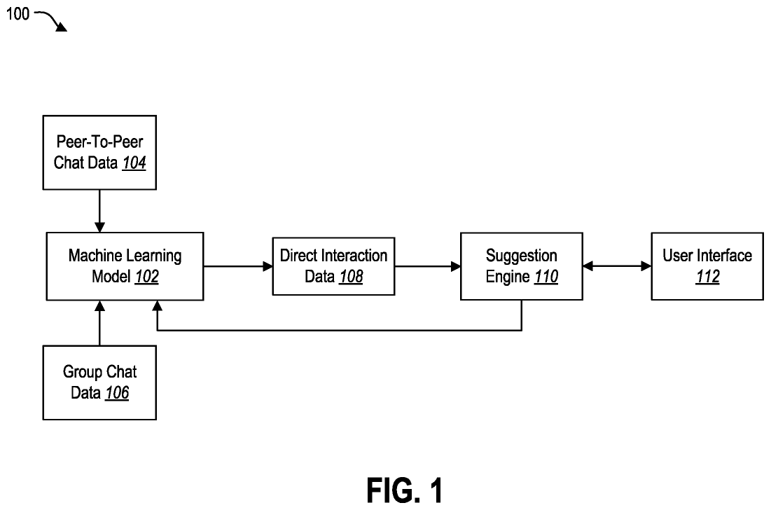

FIG. 1 illustrates an example of a system 100 for automatically generating suggestions for users based on analyzing group chats. The system 100 includes a machine learning model 102. In an example, the machine learning model 102 can be any collection of executable instructions (e.g., routine, program, object) that has been trained using a machine learning algorithm. The machine learning model 102 can be trained to recognize direct interactions between a particular user and another person. This training can be performed using data 104 from peer-to-peer chats involving the user.

There are many different kinds of machine learning algorithms that can be used to train the machine learning model 102 in accordance with the present disclosure. In some embodiments, a recurrent neural network (RNN) architecture can be used to train the machine learning model 102. Some examples of RNN architectures that could be used include long short-term memory (LSTM) RNNs, gated recurrent unit (GRU) RNNs, and bi-directional RNNs.

Once the machine learning model 102 has been trained, data 106 from group chats can be provided as input to the machine learning model 102. The machine learning model 102 can then identify direct, person-to-person interactions that occurred in the group chats. Information about such direct, person-to-person interactions can be included in data 108 that is output from the machine learning model 102. Such data 108 may be referred to herein as direct interaction data 108.

The system 100 also includes a suggestion engine 110. The suggestion engine 110 can be configured to cause information to be presented to the user based on the direct interaction data 108. The information that is presented to the user can be related to one or more people with whom the user has directly interacted in a group chat. The suggestion engine 110 can interact with a user interface 112 to present the information to the user.

When information related to a direct interaction in a group chat is presented to the user, the suggestion engine 110 can detect whether the user selects the information. For example, if the name of a person that the user interacted with in a group chat is presented to the user in a list of names, the suggestion engine 110 can detect whether the user selects that person's name (as compared to selecting another name in the list, or not selecting any of the names in the list). The suggestion engine 110 can then provide an indication of the user's selection or non-selection of the information as feedback to the machine learning model 102 for further training of the machine learning model 102. The machine learning model 102 might not always correctly identify direct, person-to-person interactions that occurred in the group chats, so providing feedback in this way can enable the machine learning model 102 to evaluate its decisions and improve the accuracy of the direct interaction data 108.

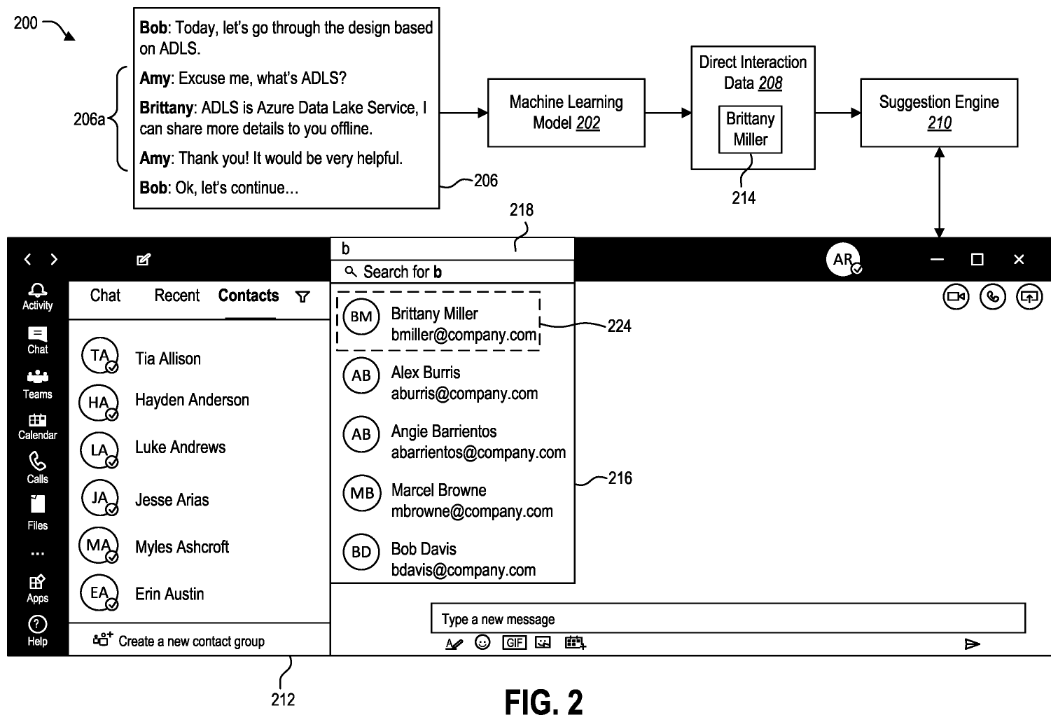

FIG. 2 illustrates another example of a system 200 for automatically generating suggestions for users based on analyzing group chats. Like the system 100 shown in FIG. 1, the system 200 includes a machine learning model 202 that has been trained to recognize direct, person-to-person interactions between a particular user and another person. In the depicted example, it will be assumed that the machine learning model 202 has been trained to recognize direct, person-to-person interactions involving a user named Amy.

A group chat 206 is shown being provided as input to the machine learning model 202. The group chat 206 can occur in a messaging application. The group chat 206 includes Amy and at least two other people: Bob and Brittany. There is a part 206a of the group chat 206 during which Amy and Brittany interact directly with one another. As the machine learning model 202 processes the group chat 206, the machine learning model 202 can recognize this direct interaction between Amy and Brittany. The machine learning model 202 can output direct interaction data 208 that includes an indication 214 that Amy interacted directly with Brittany during the group chat 206.

The system 200 also includes a suggestion engine 210 that is configured to cause information 224 to be presented to the user based on the direct interaction data 208. In the depicted example, the suggestion engine 210 presents information 224 about a person (Brittany) with whom the user (Amy) directly interacted in the group chat 206. The information 224 that is presented to the user includes the first and last name (Brittany Miller) of the person with whom the user directly interacted in the group chat 206. The information 224 also includes an email address corresponding to the person with whom the user directly interacted in the group chat 206. In an alternative embodiment, other information about the person with whom the user directly interacted in the group chat 206 can be presented to the user, such as a phone number, a picture, the name of the person's employer, an indicator about whether the person is currently online, and so forth.

In the depicted example, the information 224 that is based on the direct interaction data 208 is displayed in a graphical user interface (GUI) 212. The GUI 212 can be displayed to the user on a computing device that is being operated by the user. In an alternative embodiment, the information 224 could be presented to the user in a different way. For example, the suggestion engine 210 could include text-to-speech capability, and the information 224 could be audibly presented to the user.

The information 224 that is based on the direct interaction data 208 can be presented to the user in response to a search request from the user. In the depicted example, the name of the person (Brittany Miller) with whom the user (Amy) directly interacted in the group chat 206 is included in a drop-down list 216 that is displayed when the user enters text in a search bar 218 within the GUI 212. For example, suppose that the user wants to search for people whose first name or last name starts with the letter “b”. When the user enters the letter “b” into the search bar 218, the suggestion engine 210 can detect a match between the text that has been entered into the search bar 218 and the name of the person (Brittany) with whom the user directly interacted in the group chat 206. In response, information 224 about that person (e.g., name and email address) can be displayed in the drop-down list 216. Information about other people who satisfy the search criteria that have been entered into the search bar 218 can also be displayed in the drop-down list 216. For instance, information about other people in the user's contact list who have a first name and/or a last name that starts with the letter “b” can be displayed in the drop-down list 216.

The name of the person (Brittany) with whom the user (Amy) directly interacted in the group chat 206 can be prioritized above other names that are displayed in the drop-down list 216. In the depicted example, the name of the other person (Bob) who participated in the group chat 206 is also displayed in the drop-down list 216. If the names in the drop-down list 216 were sorted in alphabetical order, then Bob's name would appear above Brittany's name. However, because Amy did not directly interact with Bob in the group chat 206, Brittany's name is displayed above Bob's name in the drop-down list 216.

In the depicted example, the user submits a search request by entering text into a search bar 218 within the GUI 212. In an alternative embodiment, the search request could be provided in a different way. For example, the user could speak the search terms into a microphone, and the suggestion engine 210 could include voice recognition capability that interprets the audible input.

The example shown in FIG. 2 illustrates one way that the techniques disclosed herein can improve efficiency related to searching for and filtering data. The user may interact with a large number of people throughout the day, and it may be difficult for the user to remember the full name of the person (Brittany Miller) with whom the user directly interacted in the group chat 206. In the depicted example, however, the user does not have to remember the entire name of the person with whom the user interacted directly in a group chat. Instead, it is sufficient if the user merely remembers a single letter of the individual's name.

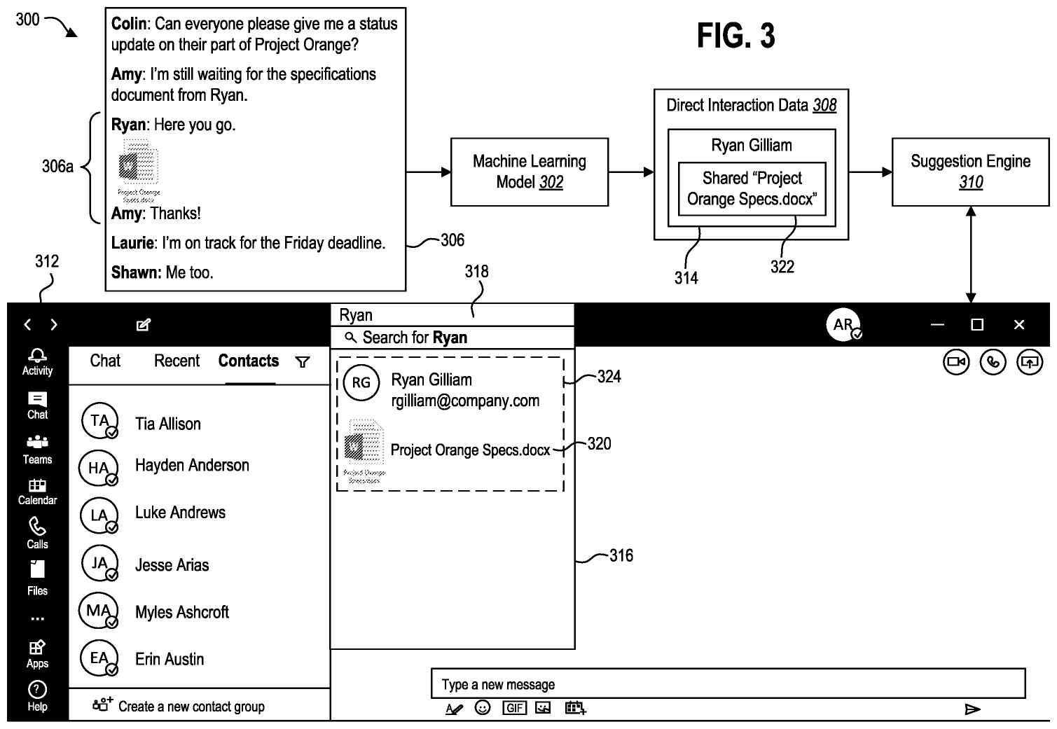

FIG. 3 illustrates another example of a system 300 for automatically generating suggestions for users based on analyzing group chats. Like the system 200 shown in FIG. 2, the system 300 includes a machine learning model 302 that has been trained to recognize direct, person-to-person interactions between a particular user and another person. It will once again be assumed that the machine learning model 302 has been trained to recognize direct, person-to-person interactions involving a user named Amy.

A group chat 306 is shown being provided as input to the machine learning model 302. The group chat 306 includes Amy and several other people, including Colin, Ryan, Laurie, and Shawn. There is a part 306a of the group chat 306 during which Amy and Ryan interact directly with one another. In particular, Ryan shares a document with Amy during this part 306a of the group chat 306. As the machine learning model 302 processes the group chat 306, the machine learning model 302 can recognize this direct interaction between Amy and Ryan. The machine learning model 302 can output direct interaction data 308 that includes an indication 314 that Amy interacted directly with Ryan during the group chat 306. The direct interaction data 308 can also include an indication 322 about the specific type of interaction that occurred. For example, the direct interaction data 308 can include an indication 322 that Ryan shared a document with Amy. This indication 322 can include information about the document that was shared, such as the name of the document (which is “Project Orange Specs.docx” in this example).

The system 300 also includes a suggestion engine 310 that is configured to cause information 324 to be presented to the user based on the direct interaction data 308. As in the previous example, this information 324 is shown being presented to the user in a GUI 312. The GUI 312 can be displayed to the user on a computing device that is being operated by the user. In an alternative embodiment, the information 324 could be audibly presented to the user.

As before, the information 324 that is presented to the user includes the name and email address of the person (Ryan Gilliam) with whom the user directly interacted in the group chat 306. In the depicted example, however, the information 324 that is presented to the user also includes a link 320 to the document that Ryan shared with Amy in the group chat 306. By activating (e.g., clicking on) this link 320, the user can open the document.

As in the previous example, the information 324 that is based on the direct interaction data 308 can be presented to the user in response to a search request from the user. For example, the information 324 can be included in a drop-down list 316 that is displayed when the user enters text in a search bar 318 within the GUI 312. In the depicted example, the user searches for the name of the person who shared the document with her. In particular, the user enters “Ryan” into the search bar 318. The suggestion engine 310 can interpret this user input as a request to search for people named “Ryan,” as well as any other relevant information about such people. Because the direct interaction data 308 includes an indication 314 that the user directly interacted with someone named Ryan Gilliam in a group chat 306, information 324 about Ryan Gilliam is presented to the user in the drop-down list 316 in response to the user input. In addition, because the direct interaction data 308 includes an indication 322 that Ryan Gilliam shared a document with Amy, the information 324 that is presented to the user includes a link 320 to the document.

The example shown in FIG. 3 illustrates another way that the techniques disclosed herein can improve efficiency related to searching for and filtering data. Even if the user is able to remember the name (Ryan) of the person with whom the user directly interacted in the group chat 206, it may be difficult for the user to remember exactly what that person shared with the user. In the depicted example, however, the user does not have to remember any specific information about the document that was shared with the user, because the name of the document is automatically presented to the user in response to the user searching for the name of the person with whom the user directly interacted in a group chat.

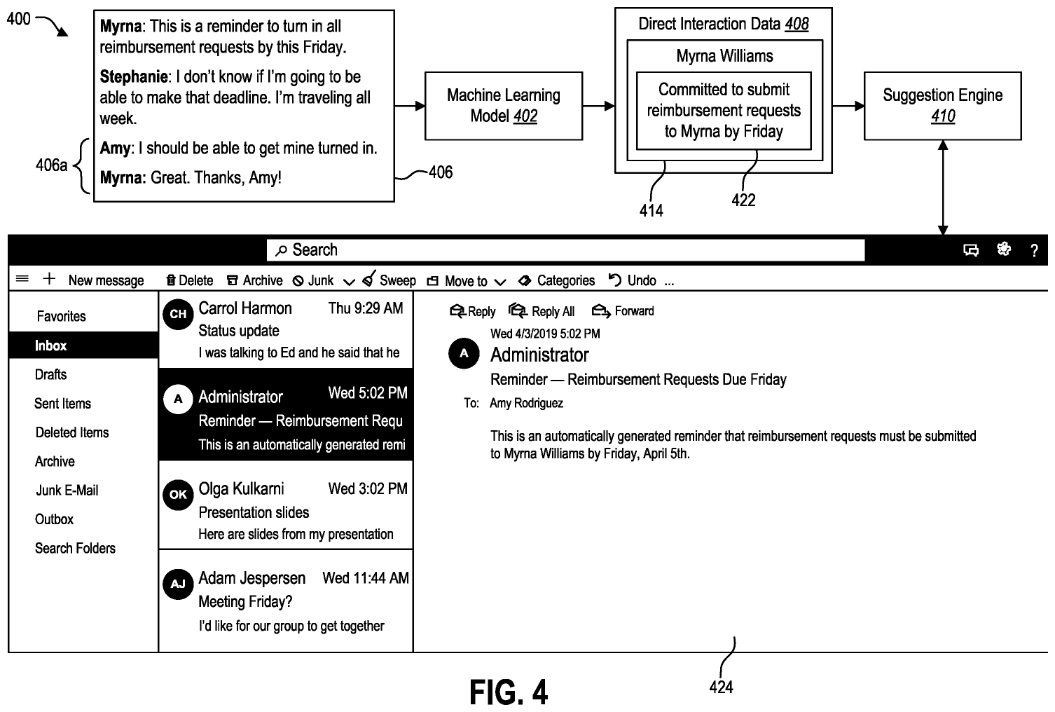

FIG. 4 illustrates another example of a system 400 for automatically generating suggestions for users based on analyzing group chats. Like the systems 200, 300 described previously in connection with FIGS. 2 and 3, the system 400 shown in FIG. 4 includes a machine learning model 402 that has been trained to recognize direct, person-to-person interactions between a particular user and another person. It will once again be assumed that the machine learning model 402 has been trained to recognize direct, person-to-person interactions involving a user named Amy.

A group chat 406 is shown being provided as input to the machine learning model 402. The group chat 406 can occur in a messaging application. The group chat 406 includes Amy and at least two other people: Myrna and Stephanie. There is a part 406a of the group chat 406 during which Amy and Myrna interact directly with one another. In particular, during this part 406a of the group chat 406, Amy makes a commitment to Myrna (namely, to submit reimbursement requests by a certain deadline).

As the machine learning model 402 processes the group chat 406, the machine learning model 402 can recognize this direct interaction between Amy and Myrna. The machine learning model 402 can output direct interaction data 408 that includes an indication 414 that Amy interacted directly with Myrna during the group chat 406. The direct interaction data 408 can also include an indication 422 about the specific type of interaction that occurred. For example, the direct interaction data 408 can include an indication 422 that Amy made a commitment to Myrna. This indication 422 can include information about the action that Amy has committed to perform (submitting reimbursement requests) and the deadline by which the action should be completed (by Friday).

The system 400 also includes a suggestion engine 410 that is configured to cause information to be presented to the user based on the direct interaction data 408. For instance, the suggestion engine 410 can cause a reminder to be provided to the user about the commitment. The reminder can be provided to the user prior to the deadline for the commitment. In the depicted example, the reminder takes the form of an email message 424. The email message 424 can be an automatically generated email message that is sent to the user a defined period of time prior to the deadline for the commitment.

In an alternative embodiment, the suggestion engine 410 can be configured to cause a different type of reminder (other than or in addition to an email message) to be provided to the user. For example, the suggestion engine 410 can cause a different type of message (e.g., a text message, an instant message, a direct message in a messaging application) to be sent to the user. As another example, the suggestion engine 410 can cause a calendar entry to be automatically created and added to the user's calendar. As another example, the suggestion engine 410 can cause an audible message to be played for the user.

In the examples discussed previously in connection with FIGS. 2 and 3, the suggestion engines 210, 310 caused information 224, 324 to be presented to the user in response to a search request that was received from the user (e.g., the user entering text into a search bar 218, 318 within a GUI 212, 312). In the example shown in FIG. 4, however, the suggestion engine 410 causes information (e.g., an email message 424) to be sent to the user without any input from the user other than the content of the group chat 406. In other words, even if the user completely forgets about the commitment after the group chat 406 has completed and takes no further action related to the commitment, the suggestion engine 410 can still cause a reminder to be sent to the user about the commitment prior to the relevant deadline.

In some embodiments, information that is obtained from analyzing group chats can be used to connect users' networks of contacts. In other words, if user A directly interacts with user B in a group chat, then someone from user B's network of contacts could be suggested to user A under appropriate circumstances. For example, if user A searches for someone with specific expertise and there is someone in user B's network of contacts who has the desired expertise, the individual from user B's network of contacts could be provided as a suggestion in response to user A's search.

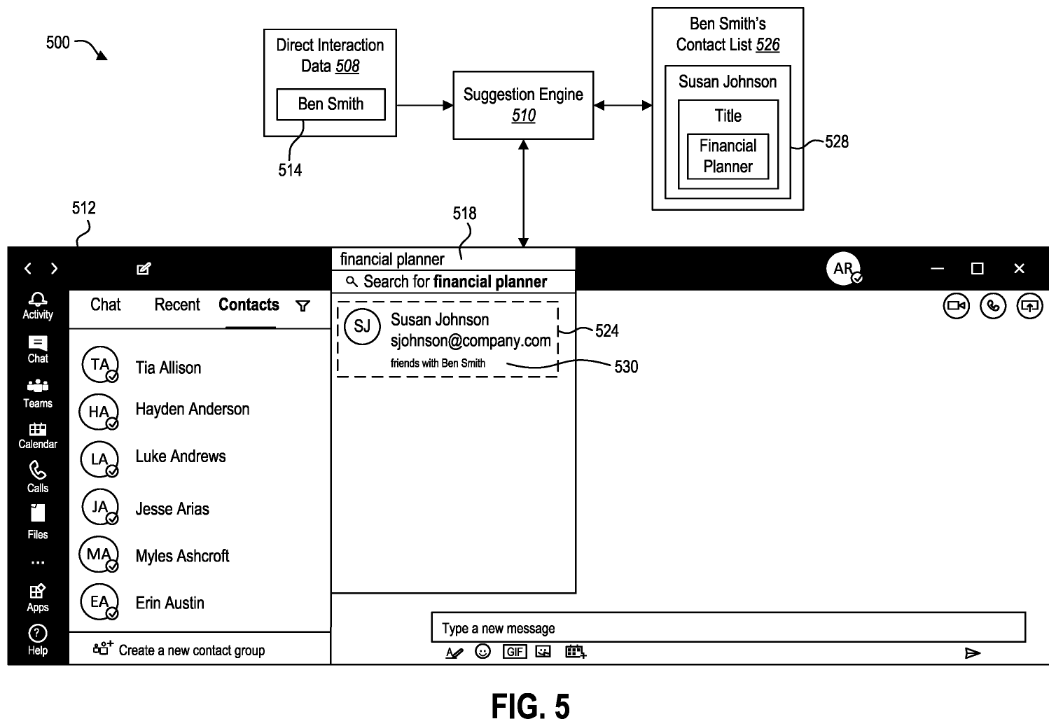

FIG. 5 illustrates an example of a system 500 in which direct interaction data 508 that is obtained from analyzing group chats can be used to connect users' networks of contacts. The direct interaction data 508 can be obtained from a machine learning model (not shown in FIG. 5) that has been trained to recognize direct interactions between a particular user and another person in group chats. The machine learning model can generate the direct interaction data 508 by processing group chats involving the user. As in the previous examples, it will be assumed that the machine learning model has been trained to recognize direct, person-to-person interactions involving a user named Amy. Thus, the direct interaction data 508 includes information about direct, person-to-person interactions involving Amy in one or more group chats.

For purposes of the present example, it will also be assumed that the user (Amy) has directly interacted with someone named Ben Smith in one or more group chats. Thus, the direct interaction data 508 includes an indication 514 about this direct interaction with Ben Smith.

As in the previous examples, the system 500 also includes a suggestion engine 510 that is configured to cause information 524 to be presented to the user based on direct interaction data 508. As with some of the examples discussed previously, the suggestion engine 510 presents information 524 to the user in response to a search request from the user. The information 524 can be based on the direct interaction data 508.

In the depicted example, instead of searching for a specific person, the user (Amy) searches for information about a specific type of service provider (e.g., a financial planner). As before, the user inputs the search request into a search bar 518 within a GUI 512. In an alternative embodiment, the search request could be provided in a different way (e.g., by speaking the search terms into a microphone).

In response to the search request, the suggestion engine 510 searches various data sources for information that matches the search terms. The data sources that are searched include a contact list 526 that corresponds to the person (Ben Smith) with whom the user has directly interacted in a group chat, as indicated by the direct interaction data 508. In the depicted example, that contact list 526 includes a record 528 that matches the search terms. In other words, the person (Ben Smith) with whom the user has directly interacted in a group chat knows someone (Susan Johnson) who has the kind of expertise for which the user is searching.

For purposes of the present example, it will be assumed that the user (Amy) does not know Susan Johnson directly. In other words, it will be assumed that Susan Johnson is not included in the user's own contact list. Thus, the example shown in FIG. 5 illustrates another way that the techniques disclosed herein can improve efficiency related to searching for data. If only the user's contact list had been searched, then no information about Susan Johnson would have been found during the search. However, because the search was expanded to include contact lists (such as Ben Smith's contact list 526) corresponding to people with whom the user had directly interacted in a group chat, information 524 about Susan Johnson can be found and presented to the user.

In the depicted example, the information 524 that is presented to the user includes the first and last name (Susan Johnson) of the person who was found during the search. The information 524 also includes an email address corresponding to that person. In addition, the information 524 includes an indication 530 about the relationship between the user and the person whose information 524 is being displayed. In the depicted example, the user has directly interacted with Ben Smith in a group chat, and the person whose information 524 is being displayed is included in Ben Smith's contact list 526. Thus, the indication 530 states that the person (Susan Johnson) whose information 524 is being displayed is “friends” with the person (Ben Smith) with whom the user has directly interacted in a group chat.

As shown, the information 524 that is presented to the user can be included in a drop-down list 516 that is displayed when the user enters text in a search bar 518 within the GUI 512. In an alternative embodiment, the information 524 could be presented to the user in a different way (e.g., presented audibly).

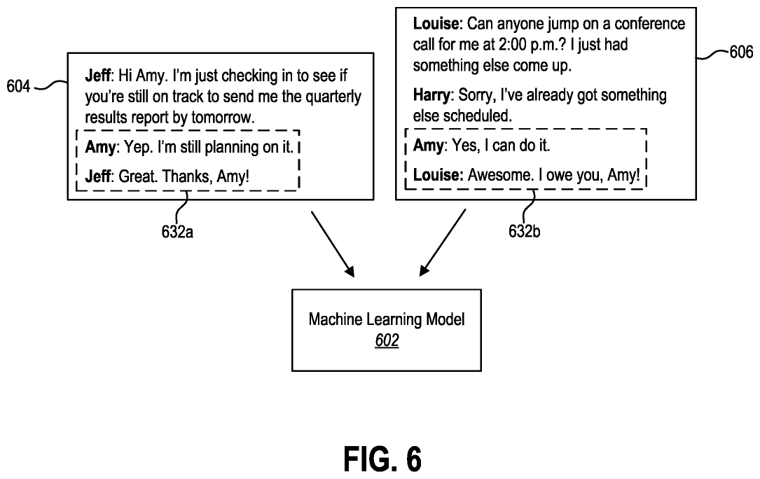

As indicated above, data from peer-to-peer chats can be used to train a machine learning model to recognize direct interactions between two people in a group chat. FIG. 6 illustrates an example showing how certain aspects of this kind of training can be carried out.

More specifically, FIG. 6 shows a peer-to-peer chat 604 and a group chat 606 being provided as input to a machine learning model 602. In general, peer-to-peer chats (such as the peer-to-peer chat 604 in FIG. 6) can be used to train the machine learning model 602. Then, once the machine learning model 602 has been trained, the machine learning model 602 can be used to identify direct, person-to-person interactions in group chats (such as the group chat 606 in FIG. 6). Of course, there can be some overlap between the training phase and the subsequent phase during which the machine learning model 602 is used to identify direct, person-to-person interactions in group chats. For example, even after the machine learning model 602 has been trained to a sufficient extent so that it can start to be used to identify direct, person-to-person interactions in group chats, additional training can be performed in order to fine tune the machine learning model 602.

For simplicity, only one peer-to-peer chat 604 and only one group chat 606 are shown in FIG. 6. However, a large number (e.g., hundreds or thousands) of peer-to-peer chats can be used to train the machine learning model 602. Then, once the machine learning model 602 has been trained, the machine learning model 602 can be used to process a large number of group chats.

During the training process, the machine learning model 602 can learn to recognize conversation patterns that are common in direct, person-to-person interactions. Peer-to-peer chats can be used for training purposes because peer-to-peer chats (which involve only two people) include only direct, person-to-person interactions. Therefore, training the machine learning model 602 can include causing the machine learning model 602 to recognize particular conversation patterns that are commonly found in peer-to-peer chats, because these conversation patterns are indicative of direct, person-to-person interactions. When similar conversation patterns are found in group chats, it can be inferred that these conversation patterns correspond to direct, person-to-person interactions.

For example, consider the part 632a of the peer-to-peer chat 604 that is shown in dotted lines in FIG. 6. In this part 632a of the peer-to-peer chat 604, the user (Amy) responds affirmatively to a statement made by another person (Jeff), and then the other person expresses gratitude to the user. If a similar conversation pattern (an affirmative response from one person followed by an expression of gratitude from another person) is found in a group chat, this can be indicative of a direct, person-to-person interaction. The machine learning model 602 can be trained to recognize conversation patterns similar to the conversation pattern in the highlighted part 632a of the peer-to-peer chat 604 by processing a large number of peer-to-peer chats that include a similar conversation pattern. When the machine learning model 602 has been trained, it can recognize a similar conversation pattern in group chats. For example, the machine learning model 602 can recognize the similar conversation pattern that is shown in the part 632b of the group chat 606 that is shown in dotted lines.

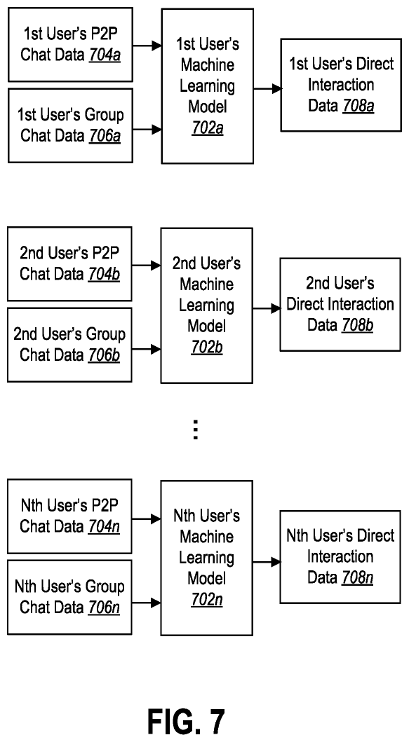

FIG. 7 illustrates an example showing how different machine learning models can be created for different users. In particular, FIG. 7 shows N different machine learning models 702a—n, including a first machine learning model 702a created for a first user, a second machine learning model 702b created for a second user, and an N^{th} machine learning model created for an N^{th} user.

Each of the machine learning models 702a—n can be trained based on peer-to-peer chat data corresponding to a particular user. For example, the first user's machine learning model 702a can be trained based on peer-to-peer chat data 704a corresponding to the first user. The second user's machine learning model 702b can be trained based on peer-to-peer chat data 704b corresponding to the second user. The N^{th} user's machine learning model 702n can be trained based on peer-to-peer chat data 704n corresponding to the N^{th} user.

The peer-to-peer chat data corresponding to a particular user can include a plurality of different peer-to-peer chats involving that user. For example, the first user's peer-to-peer chat data 704a can include a peer-to-peer chat involving the first user and person A, a peer-to-peer chat involving the first user and person B, a peer-to-peer chat involving the first user and person C, and so forth.

Once a machine learning model corresponding to a particular user has been trained, then the machine learning model can be used to identify direct, person-to-person interactions in group chat data corresponding to that user. For example, the first user's machine learning model 702a can be used to identify direct, person-to-person interactions in group chat data 706a corresponding to the first user. The second user's machine learning model 702b can be used to identify direct, person-to-person interactions in group chat data 706b corresponding to the second user. The N^{th} user's machine learning model 702n can be used to identify direct, person-to-person interactions in group chat data 706n corresponding to the N^{th} user.

The group chat data corresponding to a particular user can include a plurality of different group chats involving that user. For example, the first user's group chat data 704a can include a group chat involving the first user and a first plurality of other people (e.g., person A and person B), a group chat involving the first user and a second plurality of other people (e.g., person B and person C), a group chat involving the first user and a third plurality of other people (e.g., person C, person D, and person E), and so forth.

A machine learning model corresponding to a particular user can output direct interaction data that includes information about the direct, person-to-person interactions that are identified in that user's group chat data. For example, the first user's machine learning model 702a can output direct interaction data 708a that includes information about the direct, person-to-person interactions that are identified in the first user's group chat data 706a. The second user's machine learning model 702b can output direct interaction data 708b that includes information about the direct, person-to-person interactions that are identified in the second user's group chat data 706b. The third user's machine learning model 702c can output direct interaction data 708c that includes information about the direct, person-to-person interactions that are identified in the third user's group chat data 706c.

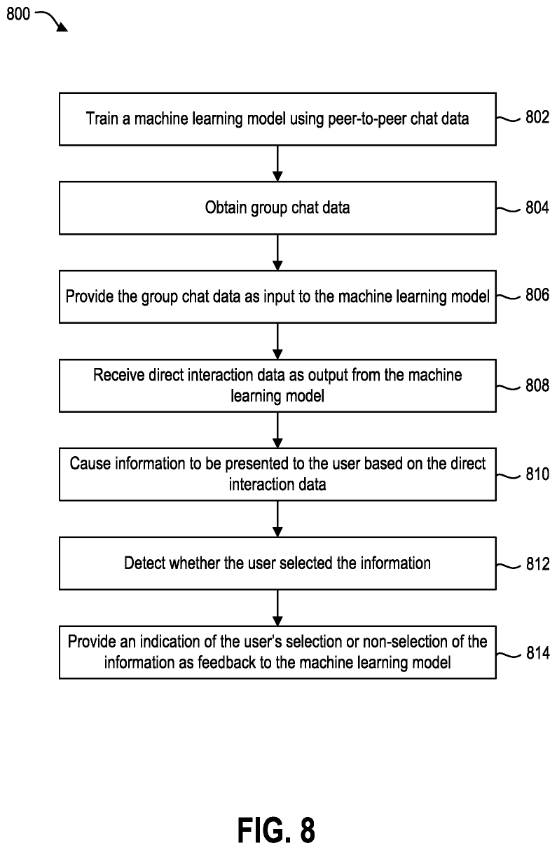

FIG. 8 illustrates an example of a method 800 for automatically generating suggestions for users based on analyzing group chats. For the sake of clarity, the method 800 will be described in relation to various examples that were discussed previously.

The method 800 can include training 802 a machine learning model 102 using peer-to-peer chat data 104. The machine learning model 102 can be trained to recognize direct interactions between a particular user and another person. During the training process, the machine learning model 102 can learn to recognize conversation patterns that are common in direct, person-to-person interactions. As discussed above, peer-to-peer chats can be used for training purposes because peer-to-peer chats (which involve only two people) include only direct, person-to-person interactions.

The method 800 can also include obtaining 804 group chat data 106. Once the machine learning model 102 has been sufficiently trained, group chat data 106 can be provided 806 as input to the machine learning model 102. The machine learning model 102 can then identify direct, person-to-person interactions that occurred in the group chats. Identifying direct, person-to-person interactions in group chats can include searching the group chats for conversation patterns that are similar to those found in peer-to-peer chats. Information about direct, person-to-person interactions can be included in direct interaction data 108 that is output from the machine learning model 102. Direct interaction data 108 can be received 808 as output from the machine learning model 102.

The method 800 can also include causing 810 information to be presented to the user based on the direct interaction data 108. The information that is presented to the user can be related to one or more people with whom the user has directly interacted in a group chat, as indicated by the direct interaction data 108. There are many different kinds of information that can be presented to the user. For example, the name of a person with whom the user has directly interacted in a group chat could be presented to the user, other information (e.g., email address, phone number, name of employer) related to a person with whom the user has directly interacted in a group chat could be presented to the user, and/or a link (e.g., the link 320 shown in FIG. 3) to a document that was shared by a person with whom the user has directly interacted in a group chat could be presented to the user.

In some embodiments, the information that is presented to the user can include a reminder about a commitment that the user made to another person. There are many different ways that such a reminder can be provided to the user. For example, a message (e.g., an email message, a text message, an instant message, a direct message in a messaging application) could be sent to the user, an audible message could be played to the user via one or more speakers on a computing device, and/or a calendar entry could be automatically created and added to the user's calendar. If there is a specific deadline associated with the commitment that the user has made, the reminder can be provided to the user prior to this deadline.

In some embodiments, the information that is related to direct interactions in group chats can be presented to the user in response to receiving a search request from the user. There are many different types of search requests that can be received. For example, a search request could include a person's name (e.g., first name and/or last name), part of a person's name (e.g., the first letter of a person's first name or last name), the name of a document, part of the name of a document, and/or one or more keywords related to a topic of interest to the user.

There are a variety of ways that a search request can be received. For example, a search request could be received via a user inputting text into a search bar 218 within a GUI 212, a user speaking into a microphone, a user selecting a user interface element within a GUI, and/or a user selecting an input button on a computing device.

When information related to a direct interaction in a group chat is presented to the user, the method 800 can also include detecting 812 whether the user selects the information. For example, if the name of a person that the user interacted with in a group chat is presented to the user in a list of names, the method 800 can include detecting whether the user selects that person's name. The method 800 can also include providing 814 an indication of the user's selection or non-selection of the information as feedback to the machine learning model 102 for further training of the machine learning model 102. Providing feedback in this way can enable the machine learning model 102 to evaluate its decisions and improve the accuracy of the direct interaction data 108.

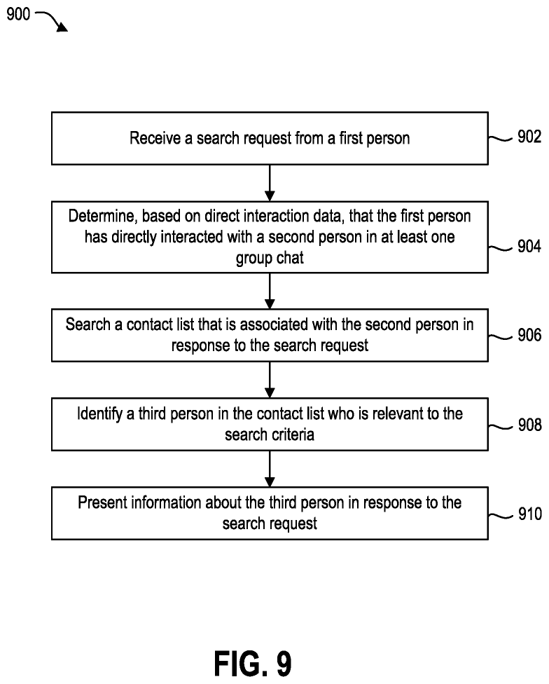

As discussed above, in some embodiments information that is obtained from analyzing group chats can be used to connect users' networks of contacts. In other words, if user A directly interacts with user B in a group chat, then someone from user B's network of contacts could be suggested to user A under appropriate circumstances. FIG. 9 illustrates an example of a method 900 in which direct interaction data that is obtained from analyzing group chats is used in this manner. For the sake of clarity, the method 900 will be described in relation to the example that was discussed previously in connection with FIG. 5.

The method 900 can include receiving 902 a search request from a first person. In response to the search request, the method 900 can also include determining 904, based on direct interaction data 108, that the first person has directly interacted with a second person in at least one group chat. For example, referring to the system 500 shown in FIG. 5, a search request can be received via a first person (Amy) entering keywords (“financial planner”) into a search bar 518 within a GUI 512. In response to receiving such a search request, the suggestion engine 510 can determine, based on direct interaction data 508, that the first person (Amy) has directly interacted with a second person (Ben Smith) in one or more group chats.

Based on determining that the first person has directly interacted with the second person in at least one group chat, the method 900 can include searching 906 a contact list that is associated with the second person. During the search, a third person who is relevant to the search criteria can be identified 908. Information about this third person can be presented 910 in response to the search request.

For example, referring once again to the system 500 shown in FIG. 5, the method 900 can include searching a contact list 526 that is associated with the second person (Ben Smith). During the search, a third person (Susan Johnson) can be identified 908 in the second person's contact list 526. In this particular example, the third person is relevant to the search criteria because the first person (Amy) searched for a “financial planner” and a record 528 in the second person's contact list 526 indicates that the third person (Susan Johnson) is a financial planner. Therefore, information 524 about Susan Johnson can be presented to the first person (Amy). The information 524 that is presented can include an indication 530 about the relationship between the second person (Ben Smith) and the person whose information 524 is being displayed.

As discussed above, the present disclosure is generally related to automatically generating suggestions for users based on analyzing group conversations or chats. For simplicity, the examples discussed above have been described in terms of electronic chats.

However, the techniques disclosed herein are applicable to any kind of electronic conversation.

The conversations and chats described herein are electronic conversations and chats. In other words, a conversation or chat can include a plurality of electronic messages that are exchanged between at least two people via computing devices (and possibly computer networks).

The direct, person-to-person interactions described herein are direct, person-to-person interactions that occur in an electronic conversation or chat. In other words, a direct, person-to-person interaction involves the exchange of electronic messages between two people who are involved in an electronic conversation or chat.

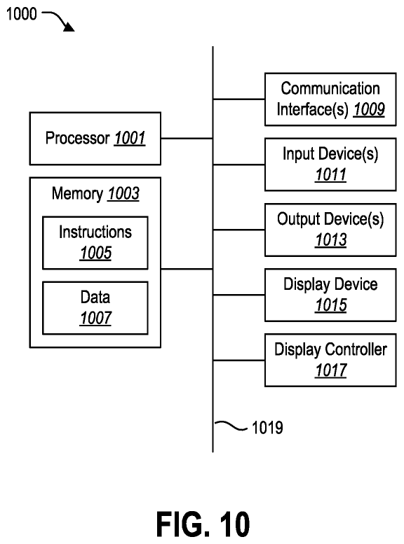

One or more computing devices 1000 can be used to implement at least some aspects of the techniques disclosed herein. FIG. 10 illustrates certain components that can be included within a computing device 1000.

The computing device 1000 includes a processor 1001 and memory 1003 in electronic communication with the processor 1001. Instructions 1005 and data 1007 can be stored in the memory 1003. The instructions 1005 can be executable by the processor 1001 to implement some or all of the methods, steps, operations, actions, or other functionality that is disclosed herein. Executing the instructions 1005 can involve the use of the data 1007 that is stored in the memory 1003. Unless otherwise specified, any of the various examples of modules and components described herein can be implemented, partially or wholly, as instructions 1005 stored in memory 1003 and executed by the processor 1001. Any of the various examples of data described herein can be among the data 1007 that is stored in memory 1003 and used during execution of the instructions 1005 by the processor 1001.

Although just a single processor 1001 is shown in the computing device 1000 of FIG. 10, in an alternative configuration, a combination of processors (e.g., an ARM and DSP) could be used.

The computing device 1000 can also include one or more communication interfaces 1009 for communicating with other electronic devices. The communication interface(s) 1009 can be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing device 1000 can also include one or more input devices 1011 and one or more output devices 1013. Some examples of input devices 1011 include a keyboard, mouse, microphone, remote control device, button, joystick, trackball, touchpad, and lightpen. One specific type of output device 1013 that is typically included in a computing device 1000 is a display device 1015. Display devices 1015 used with embodiments disclosed herein can utilize any suitable image projection technology, such as liquid crystal display (LCD), light-emitting diode (LED), gas plasma, electroluminescence, or the like. A display controller 1017 can also be provided, for converting data 1007 stored in the memory 1003 into text, graphics, and/or moving images (as appropriate) shown on the display device 1015. The computing device 1000 can also include other types of output devices 1013, such as a speaker, a printer, etc.

The various components of the computing device 1000 can be coupled together by one or more buses, which can include a power bus, a control signal bus, a status signal bus, a data bus, etc. For the sake of clarity, the various buses are illustrated in FIG. 10 as a bus system 1019.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, on-board memory included with a processor, erasable programmable read-only memory (EPROM), electrically erasable programmable read-only memory (EEPROM) memory, registers, and so forth, including combinations thereof.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A system, comprising:
a machine learning model that has been trained, based on peer-to-peer chats involving a first person, to recognize direct interactions between the first person and another person;
direct interaction data that indicates direct, person-to-person interactions involving the first person in a plurality of group chats, wherein the direct interaction data is generated by the machine learning model in response to processing group chat data corresponding to the plurality of group chats; and
a suggestion engine that is configured to cause information to be presented to the first person based on the direct interaction data, wherein the information is related to one or more people with whom the first person has directly interacted in a group chat.

2. The system of claim 1, wherein the suggestion engine is configured to cause the information to be presented to the first person in response to receiving a search request from the first person.

3. The system of claim 2, wherein:
the search request comprises a first letter of a name of a second person;
the information that is presented to the first person comprises the name of the second person; and
the suggestion engine is configured to prioritize the name of the second person above other names that have a same first letter as the name of the second person.

4. The system of claim 2, wherein:
the search request comprises a name of a second person; and
the information that is presented to the first person comprises a link to a document that the second person previously shared with the first person.

5. The system of claim 2, wherein:
the search request comprises a request to search for documents that were previously shared with the first person; and
the information that is presented to the first person comprises a link to a document that a second person previously shared with the first person.

6. The system of claim 1, wherein the information that is presented to the first person comprises a reminder about a commitment that the first person made to a second person.

7. The system of claim 1, wherein:
the information is presented to the first person in response to receiving a search request from the first person;
the direct interaction data indicates that the first person has directly interacted with a second person in at least one group chat; and
the suggestion engine is additionally configured to search a contact list that is associated with the second person in response to the search request.

8. The system of claim 7, wherein:
the information that is presented to the first person comprises a name of a third person;
the third person is in the contact list that is associated with the second person; and
the third person is not in any contact list that is associated with the first person.

9. The system of claim 1, wherein the suggestion engine is additionally configured to:
detect whether the first person selected the information; and
provide an indication of the first person's selection or non-selection of the information as feedback to the machine learning model for further training of the machine learning model.

10. A method, comprising:
providing group conversation data as input to a machine learning model, wherein the group conversation data corresponds to a plurality of group conversations involving a first person, wherein the machine learning model has been trained to recognize direct interactions between the first person and another person;
receiving direct interaction data as output from the machine learning model, wherein the direct interaction data indicates direct, person-to-person interactions between the first person and another person in the plurality of group conversations, and wherein the direct interaction data is generated by the machine learning model in response to processing the group conversation data; and
causing information to be presented to the first person based on the direct interaction data, wherein the information is related to one or more people with whom the first person has directly interacted in a group conversation.

11. The method of claim 10, further comprising training the machine learning model using peer-to-peer conversation data from peer-to-peer conversations involving the first person.

12. The method of claim 10, wherein:
the method further comprises receiving a search request from the first person; and
the information is presented to the first person in response to the search request.

13. The method of claim 12, wherein:
the search request comprises a first letter of a name of a second person;
the information that is presented to the first person comprises the name of the second person; and
the method further comprises prioritizing the name of the second person above other names that have a same first letter as the name of the second person.

14. The method of claim 12, wherein:
the search request comprises a name of a second person; and
the information that is presented to the first person comprises a link to a document that the second person previously shared with the first person.

15. The method of claim 12, wherein:
the search request comprises a request to search for documents that were previously shared with the first person; and
the information that is presented to the first person comprises a link to a document that a second person previously shared with the first person.

16. The method of claim 10, wherein the information that is presented to the first person comprises a reminder about a commitment that the first person made to a second person.

17. The method of claim 10, further comprising:
receiving a search request from the first person;
determining, based on the direct interaction data, that the first person has directly interacted with a second person in at least one group conversation; and
searching a contact list that is associated with the second person in response to the search request.

18. The method of claim 17, wherein:
the information that is presented to the first person comprises a name of a third person;
the third person is in the contact list that is associated with the second person; and
the third person is not in any contact list that is associated with the first person.

19. The method of claim 10, further comprising:
detecting whether the first person selected the information; and
providing an indication of the first person's selection or non-selection of the information as feedback to the machine learning model for further training of the machine learning model.

20. A method, comprising:
training a first machine learning model to recognize direct interactions involving a first person, wherein the training of the first machine learning model is based on a first plurality of peer-to-peer chats involving the first person;
training a second machine learning model to recognize direct interactions involving a second person, wherein the training of the second machine learning model is based on a second plurality of peer-to-peer chats involving the second person;
obtaining direct interaction data that indicates direct, person-to-person interactions in a plurality of group chats, wherein the direct interaction data is generated by the first machine learning model and the second machine learning model in response to processing group chat data corresponding to the plurality of group chats; and
causing information related to the direct, person-to-person interactions to be presented to the first person and the second person based on the direct interaction data.
